(19) United States
(12) Patent Application Publication
(10) Pub. No.: US 2013/0031091 A1
(43) Pub. Date: Jan. 31, 2013

(54) ACTION-BASED SEARCH RESULTS AND ACTION VIEW PIVOTING

(71) Applicants: ANTOINE EL DAHER, KENMORE, WA (US); DEEPAK VIJAYWARGI, SEATTLE, WA (US)

(72) Inventors: ANTOINE EL DAHER, KENMORE, WA (US); DEEPAK VIJAYWARGI, SEATTLE, WA (US)

(73) Assignee: MICROSOFT CORPORATION, REDMOND, WA (US)

(21) Appl. No.: 13/528,508

(22) Filed: Jun. 20, 2012

Related U.S. Application Data
(63) Continuation-in-part of application No. 13/190,744, filed on Jul. 26, 2011.

(51) Int. Cl. G06F 17/30

(52) U.S. Cl. 707/723; 707/E17.082

(57) ABSTRACT

Action-based search results are provided that include deeplinks to a particular action to allow an end user to view various locations for performing that action and to quickly access those locations to perform the action. In some instances, when a search query is received, the search query may be identified as corresponding with a particular action. Action-based search-results with deeplinks to locations for performing that action are identified and returned. In other instances, traditional search results may be provided in response to a search query. One of the search results may include an action-based deeplink for a particular action. An action-pivot link may be provided for that action that, when selected, causes action-based search results for that action to be identified and returned for presentation to the end user.

### CROSS-REFERENCE TO RELATED APPLICATIONS

This application is a continuation-in-part of U.S. patent application Ser. No. 13/190,744, filed Jul. 26, 2011, which is herein incorporated by reference in its entirety. This application is also related by subject matter to the inventions disclosed in the following U.S. patent applications: U.S. application Ser. No. 13/406,181, filed Feb. 27, 2012, (Attorney Docket Number 335156.01/MFCP.165729) entitled “Context-Aware Parameterized Action Links for Search Results;” U.S. application Ser. No. 13/406,192, filed Feb. 27, 2012, (Attorney Docket Number 335157.01/MFCP.165730), entitled “Personalized Deeplinks for Search Results;” and U.S. application Ser. No. 13/406,203, filed Feb. 27, 2012, (Attorney Docket Number 335158.01/MFCP.165731), entitled “Surfacing Actions from Social Data;” which are assigned or under obligation of assignment to the same entity as this application, and incorporated in this application by reference.

### BACKGROUND

The amount of information and content available on the Internet continues to grow exponentially. Given the vast amount of information, search engines have been developed to facilitate web searching. In particular, users may search for information and documents by entering search queries comprising one or more terms that may be of interest to the user. After receiving a search query from a user, a search engine identifies documents and/or web pages that are relevant based on the terms. A search page is returned with a list of hyperlinks to “landing pages” that correspond with the identified documents and/or web pages. Because of its utility, web searching, that is, the process of finding relevant web pages and documents for user-issued search queries has arguably become one of the most popular services on the Internet today. However, in some instances, when a user selects a search result and accesses a landing page, although that landing page may be within a website (i.e., collection of web pages within a given domain) that contains the information the user is after, that particular landing page may not have the relevant information. As a result, the user may have to browse or search pages within the website to find the information the user is seeking.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing action-based search results given a particular action. Each action-based search result includes a deeplink to a corresponding web page for performing the particular action. In some instances, a search query may be received from an end user, and an action may be identified as corresponding with the search query. Action-based search results are selected based on the identified action and returned for presentation to the end user. The action-based search results may be provided in an action view that identifies the action and lists the action-based search results with deeplinks for the action.

In other instances, when traditional search results are returned in response to a search query, one of the search results may include an action-based deeplink corresponding with a particular action. Based on the action-based deeplink, an action-pivot link may be provided with the search results. If the action-pivot link is selected by the end user, action-based search results corresponding with the particular action may be identified and provided for presentation to the end user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a screenshot providing an example of a search result with action-based deeplinks in accordance with an embodiment of the present invention;

FIG. 4 is a screenshot providing another example of a search result with an action-based deeplink in accordance with an embodiment of the present invention;

FIG. 5 is a flow diagram showing a method for identifying action-based deeplinks in accordance with an embodiment of the present invention;

FIG. 6 is a flow diagram showing a method for identifying action-based deeplinks in accordance with another embodiment of the present invention;

FIG. 7 is a flow diagram showing a method for returning a search result with an action-based deeplink in accordance with an embodiment of the present invention;

FIGS. 8 is a screenshot providing an example of an action view with action-based search results in accordance with an embodiment of the present invention;

FIG. 9 is a screenshot providing an example of a traditional search result view with search result having an action-pivot link in accordance with an embodiment of the present invention;

FIG. 10 is a flow diagram showing a method for providing action-based search results based on an action associated with a search query in accordance with an embodiment of the present invention;

FIG. 11 is a flow diagram showing a method for analyzing a search query to determine if it is an action-based search query and providing appropriate search results based on the analysis in accordance with an embodiment of the present invention;

FIG. 12 is a flow diagram showing a method for allowing an end user to pivot from a traditional search result view to an action view in accordance with an embodiment of the present invention;

FIG. 13 is a block diagram of an exemplary system in which embodiments of the invention may be employed;

FIG. 14 is a screenshot providing an example of traditional search result views that includes a paid search result with an action-based deeplink in accordance with an embodiment of the present invention; and

FIG. 15 is a screenshot providing an example of an action view with action-based search results that include a paid action-based search result in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As discussed above, one problem that users may face when employing search engines is that although a search result returned may correspond with a web page within a website containing the relevant information the user is seeking or a particular action the user wishes to perform, the user may be required to browse the website after selecting the search result to find the information or to perform the action. For instance, suppose a user wishes to check into a flight on an airline. The user may issue a search query for the airline and receive search results that include a hyperlink to the main web page of the website for the airline. After selecting the hyperlink to the main web page for the airline, the user would then need to find a location within the web site for checking into the flight. In some cases, this may be a time-consuming task.

One approach to addressing this problem has been the inclusion of deeplinks in search results on search result pages. As used herein, the term “deeplinks” refers to additional hyperlinks that are provided in association with a matching search result. In other words, a search result may include a hyperlink to a main destination web page, as well as deeplinks to other web pages to which the main destination web page links. For instance, in the example above, the main web page for the airline (i.e., the main destination web page) may include a hyperlink to a web page within the airline's website for logging into flights for the airline. Accordingly, a hyperlink to the location for checking into flights for the airline could be included as a deeplink in association with the hyperlink to the main web page for the airline provided as a search result to a user's search query. Although deeplinks allow users to more quickly access the information they are seeking or perform particular actions, the deeplinks included in search results vary from web page to web page, resulting in a fragmented experience for users. As a result, users may not quickly recognize a deeplink and may even simply select the hyperlink to the main destination web page for the search result, thereby missing out on the benefits of the deeplinks.

Some embodiments of the present invention are directed to providing action-based deeplinks with search results to provide a more consistent experience across web pages within a category of web pages. The action-based deeplinks link to locations that allow users to perform actions that are common to a given web page category. For instance, suppose that a web page category is an airline category, which includes the web pages of different airlines. The action-based deeplinks that may be provided would link to locations within the airline websites that allow users to perform airline-related actions such as checking into flights, check the status of flights, and booking flight reservations. To provide a consistent experience, the search results for airline web pages returned in response to search queries may have the same type of action-based deeplinks. While the action-based deeplinks are similar to traditional deeplinks, the action-based deeplinks differ from traditional deeplinks in that while traditional deeplinks are specific to a given web page, the action-based deeplinks are similar for web pages within a given category, thereby providing a more consistent user experience. This approach makes it easier for users to quickly navigate to a desired location and perform key tasks, thereby reducing the overall time required to perform the tasks.

In some aspects, action-based deeplinks may be identified for web pages by first categorizing web pages into a variety of categories. Each category is then analyzed to identify action-based deeplinks for web pages in each category. For a given category, hyperlinks within web pages of that category are identified and grouped into a number of clusters. Each cluster may correspond with a particular action users perform when visiting the web pages. For instance, in the example of airlines categories, the actions may include checking into a flight, check the status of a flight, and making flight reservations. Hyperlinks are identified within web pages that allow users to perform each action. Based on that information, action-based deeplinks may be provided when returning search results for those web pages. Again, because the action-based deeplinks may be similar among web pages within a given category, a more consistent user experience may be provided that allows users to more quickly perform desired tasks.

Action-based search results having deeplinks to a particular action may be identified and returned in response to identifying the particular action. In some instances, when a search query is received, the search query may be analyzed to identify a particular action associated with the search query. Based on the identified action, search results having deeplinks to web pages to perform that particular action may be identified and returned in response to the search query. In other instances, when an end user submits a search query and search results are returned that include a search result with an action-based deeplink for a particular action, an action-pivot link may be provided that when selected, causes action-based search results to be identified that have deeplinks corresponding with that action. Those action-based search results are then provided for presentation to the end user. In that manner, the user may pivot back and forth on a search engine results page between a traditional search result view having search results returned based on a search engine's traditional search algorithms and an action view having action-based search results corresponding with a particular action.

Accordingly, in one aspect, an embodiment of the present invention is directed to one or more computer storage media storing computer-useable instructions that, when used by one or more computing devices, cause the one or more computing devices to perform a method. The instructions include receiving a search query from an end user. The instructions also include identifying an action associated with the search query. The instructions further include identifying a plurality of search results based on the action, each search result having an action-based deeplink to a corresponding web page for performing the action. The instructions still further include providing a search result set for presentation to the end user, the search result set including the plurality of search results.

In another embodiment, an aspect is directed to a method. The method includes receiving a search query from an end user. The method also includes analyzing the search query to determine if the search query is an action-based search query. If it is determined that the search query is not an action-based search query, the method includes: identifying search results relevant to the search query, and providing the search results relevant to the search query for presentation to the end user. If it is determined that the search query is an action based search query, the method includes identifying an action corresponding with the search query, identifying action-based search results based on the action, each action-based search result having an action-based deeplink to a corresponding webpage for performing the action, and providing the action-based search results for presentation to the end user.

A further embodiment of the present invention is directed to one or more computer storage media storing computer-useable instructions that, when used by one or more computing devices, cause the one or more computing devices to perform a method. The instructions include receiving a search query from an end user. The instructions also include identifying a plurality of search results relevant to the search query, a first search result within the plurality of search results having a deeplink to a webpage for performing an action. The instructions further include providing the plurality of search results for presentation to an end user, wherein the first search result includes an action-pivot link corresponding with the action. The instructions also include receiving an indication that the end user has selected the action-pivot link. The instructions further include responsive to receiving the indication that the end user has selected the action-pivot link, identifying a plurality of action-based search results, each action-based search result including a deeplink to a corresponding webpage for performing the action. The instructions still further include providing the action-based search results for presentation to the end user.

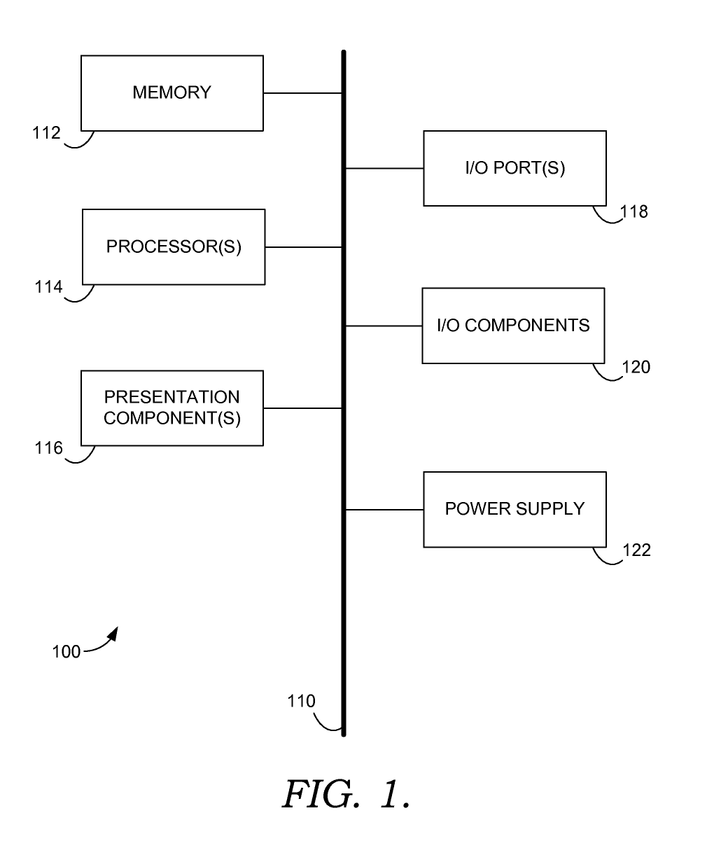

Having described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Action-Based Deeplinks

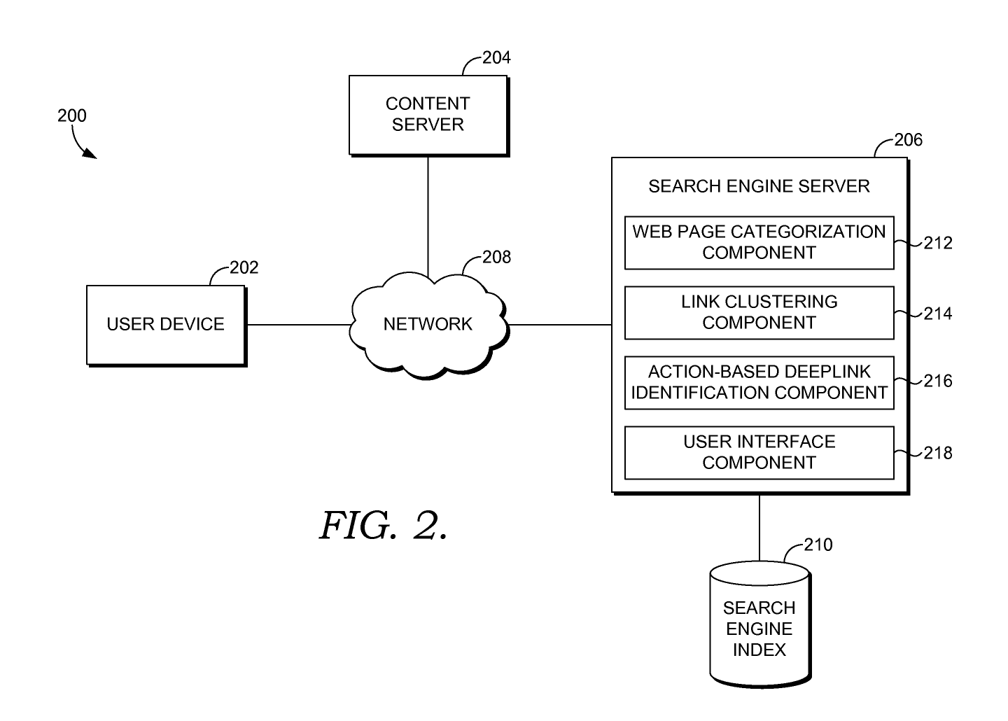

As previously indicated, action-based deeplinks may be provided with search results to allow users to access and perform actions that are common to web pages within a given category. Referring to FIG. 2, a block diagram is provided illustrating an exemplary system 200 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a user device 202, content server 204, and search engine server 206. Each of the components shown in FIG. 2 may be any type of computing device, such as computing device 100 described with reference to FIG. 1, for example. The components may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of user devices, content servers, and search engine servers may be employed within the system 200 within the scope of the present invention. Each may comprise a single device or multiple devices cooperating in a distributed environment. For instance, the search engine server 206 may comprise multiple devices arranged in a distributed environment that collectively provide the functionality of the search engine server 206 described herein. Additionally, other components not shown may also be included within the system 200.

The search engine server 206 generally operates to index information regarding web pages served by content servers, such as the content server 204, in a search engine index 210. When the search engine server 206 receives search queries from user devices, such as the user device 202, the search engine queries the search engine index 210 to identify search results based on the users' search queries and returns those search results to the user devices. In accordance with embodiments of the present invention, the search engine server 206 is also configured to identify action-based deeplinks for some web pages and to provide those action-based deeplinks when providing search results corresponding with those web pages.

In the embodiment shown in FIG. 2, the search engine server 206 includes, among other things, a web page categorization component 212, a link clustering component 214, an action-based deeplink identification component 216, and a user interface component 218.

The web page categorization component 212 operates to identify a category for each of a number of different web pages served by content servers, such as the content server 204, and indexed in the search engine index 210. As a result, web pages are clustered together into various categories. By way of example only and not limitation, the web page categorization component 212 may identify web pages within a restaurants category, hotels category, airlines category, and social networks category, to name a few.

Web page categorization may be performed in any of a number of different manners within the scope of embodiments of the present invention. In some embodiments, the categorization may be based on an existing repository of web page categorizations, such as the Open Directory Project (ODP). In some embodiments, web pages may be automatically grouped together into categories by analyzing the content of the pages. For instance, clustering techniques may be employed to cluster the web pages based on their content. As another example, the web pages may be categorized by looking for particular keywords in the content of the web pages. Web page categorization could also be automatically performed by analyzing the hyperlinks within the content of the web pages. Web page categorization may also include a manual approach based on editorial review of web pages to manually place the web pages into the different categories. In still further embodiments, a sample of manually-categorized web pages may be used as seeds for an automatic approach in which other web pages are compared against the seed web pages to categorize the other web pages. Any and all such variations and combinations thereof are contemplated to be within the scope of embodiments of the present invention.

The link clustering component 214 operates to cluster hyperlinks found on web pages within each category. For a given category, the link clustering component 214 may analyze hyperlinks contained within the web pages within that given category to cluster the hyperlinks into a number of clusters. The clustering may be performed in some embodiments by analyzing the words in the anchor text of the hyperlinks. As is known in the art, the anchor text refers to the displayed text of a hyperlink. Hyperlinks containing similar words would be clustered together. In some embodiments, the content of each hyperlink's destination web page may be analyzed to cluster the hyperlinks. In still further embodiments, the clustering may include manual review of hyperlinks and/or destination web pages of the hyperlinks to facilitate clustering.

In some embodiments, the link clustering component 214 may analyze and cluster all hyperlinks within each web page within the category. In other embodiments, the link clustering component 214 may cluster only a portion of hyperlinks from the web pages. For instance, the link clustering component 214 may consider only the hyperlinks that meet some threshold based on user clicks on the hyperlinks. In some embodiments, the search engine server 206 may receive click-through data collected by web browsers, search toolbars, or other mechanisms on user devices, such as the user device 202. The click-through data may indicate the hyperlinks that users have clicked within web pages when viewing those web pages. Based on such click-through data, the most-clicked hyperlinks on a given web page may be identified and only those hyperlinks considered by the link cluster component 214. For instance, only the hyperlinks that have received a threshold number of clicks or that have a threshold click-through rate (i.e., the percentage of web page visits for the web page that have resulted in a click on the hyperlink) may be considered.

In some embodiments, the search engine server 206 may be configured to provide traditional deeplinks. In such embodiments, the link clustering component 214 may consider only hyperlinks corresponding with the deeplinks for the web page. All deeplinks may be considered in some embodiments, while only a portion of the deeplinks may be considered in other embodiments. For an example of the latter, the search engine server 206 may track user clicks of deeplinks from search results. Based on such click data, the search engine server 206 may identify the hyperlinks that correspond with the most-clicked deeplinks and only those hyperlinks considered by the link cluster component 214. For instance, only the hyperlinks that correspond with deeplinks that have received a threshold number of clicks or that have a threshold click-through rate (i.e., the percentage of search results for the web page that have resulted in a click on the deeplink) may be considered.

Based on the clustering of hyperlinks from the link clustering component 214, the action-based deeplink identification component 216 may identify one or more different types of actions for the web page category being analyzed. In particular, each action may correspond with a type of action users perform using hyperlinks within a cluster of hyperlinks. For instance, if the web page categorization being analyzed is an airlines category, a first cluster of hyperlinks may correspond with locations for checking into flights, a second cluster of hyperlinks may correspond with locations for checking the status of flights, and a third cluster of hyperlinks may correspond with locations book making flight reservations. As such, a check in action may be identified based on first cluster of hyperlinks, a check status action may be identified based on the second cluster of hyperlinks, and a reservations action may be identified based on the third cluster of hyperlinks.

In some embodiments, the action-based deeplink identification component 216 may consider each cluster identified by the link clustering component 214 and identify an action for each of those clusters. In other embodiments, only clusters that meet some threshold may be processed by the action-based deeplink identification component 214 to identify an action for each of those clusters. For instance, in some embodiments, only clusters that include a threshold number of hyperlinks may be further processed by the action-based deeplink identification component 214. In some embodiments, click-through rates for each hyperlink in a cluster may be analyzed to determine whether to process the cluster. In such embodiments, actions may be identified only for clusters with hyperlinks that satisfy a threshold level of click-throughs. The click-through data may represent user clicks on hyperlinks when visiting the web page. Such click-though data may be collected by web browsers, search engine tool bars, or other mechanisms on user devices, such as the user device 202, and provided to the search engine server 206. In instances in which the hyperlinks correspond with deeplinks, deeplink click-through data may be employed. The deeplink click-through data represents user clicks on deeplinks presented in search results.

After identifying an action for a web page category, the action-based deeplink identification component 216 may identify, for web pages within the category, hyperlinks that correspond with that action. For instance, if the web page category being analyzed is an airlines category and an identified action is checking into flights, hyperlinks on web pages within the category that link to locations that allow users to check into flights would be identified as corresponding with that action. The URL for those locations or other information may then be stored in association with each web page in the search engine index 210 to allow for providing action-based deeplinks when returning search results to search queries.

A hyperlink corresponding with an action may be identified for web pages within a given category in a number of different ways. In some instances, the hyperlinks may be identified from the cluster of hyperlinks for that action. In some cases, a web page may not have had a hyperlink placed in that cluster. For such a web page, hyperlinks from that web page may be analyzed to identify a hyperlink that corresponds with the action. This may include, for instance, automatically analyzing the anchor text of hyperlinks and/or the content of the destination web pages of the hyperlinks to identify a hyperlink that corresponds with the action. For instance, the anchor text or content of the destination web page for a hyperlink may be compared against the anchor text and/or destination web page content for hyperlinks in the cluster of hyperlinks used to identify the action. In some embodiments, editors may manually review web pages to identify hyperlinks that correspond with an action. Any and all such variations and combinations thereof are contemplated to be within the scope of embodiments of the present invention.

In some embodiments, a hyperlink may be identified for a particular action for only a portion of web pages in the category. In other embodiments, a hyperlink for an action may be identified for most or even all web pages in the category. In this way, an action-based deeplink may be provided with search results for the web pages in the category to provide users with a consistent experience. This would allow users to more quickly get to the information and perform desired actions.

The user interface component 218 provides an interface to user devices, such as the user device 202, that may allow users to submit search queries to the search engine server 206 and to receive search results from the search engine server 206. It should be understood that the user device 202 may be any type of computing device employed by a user to submit search queries and receive search results. By way of example only and not limitation, the user device 202 may be a desktop computer, a laptop computer, a tablet computer, a mobile device, or other type of computing device. The user device 202 may include an application that allows a user to enter a search query and submit the search query to the search engine server 206 to retrieve search results. For instance, the user device 202 may include a web browser that includes a search input box or allows a user to access a search page to submit a search query. Other mechanisms for submitting search queries to search engines are contemplated to be within the scope of embodiments of the present invention.

When the search engine server 206 receives a search query, the search engine index 210 is queried to identify search results. In some instances, a search result may have a corresponding action-based deeplink that has been identified by the action-based deeplink identification component 216. Accordingly, when the search engine server 206 returns the search result to the user device 202, the search result includes not only a hyperlink to the destination web page of the search result, but also an action-based deeplink that links to a location that allows the user to perform a corresponding action. In some embodiments, the search engine server 206 may return a search result that includes a hyperlink to the destination web page of the search result, one or more traditional deeplinks, and one or more action-based deeplinks based on information indexed for a web page corresponding with the search result.

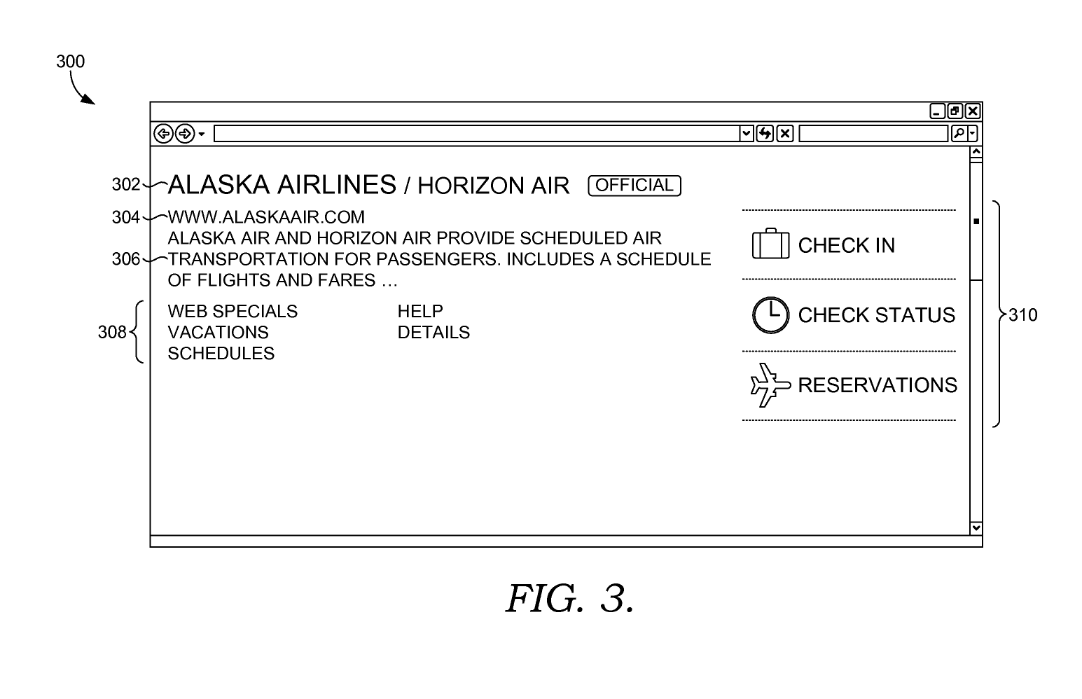

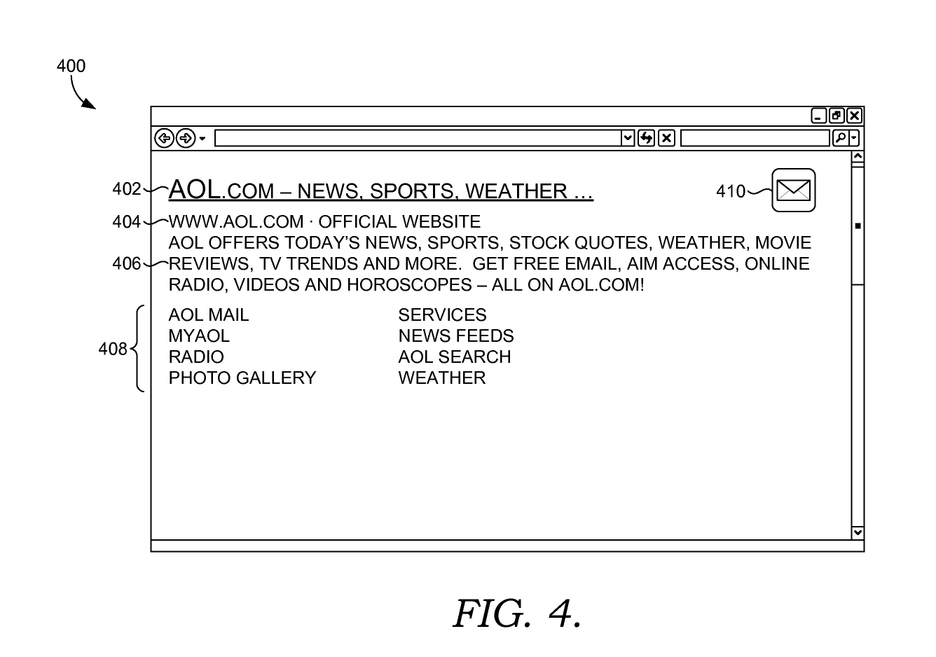

Examples of search results that include action-based deeplinks are illustrated in the screen displays shown in FIGS. 3 and 4. It should be understood and appreciated by those of ordinary skill in the art that the screen displays of FIGS. 3 and 4 are provided by way of example only and are not intended to limit the scope of the present invention in any way.

Referring first to FIG. 3, a search result 300 is displayed that corresponds with the ALASKA AIRLINES web page. The search result 300 may be provided in response to a search query, such as “alaska airlines.” As shown in FIG. 3, the search result 300 includes a title 302, the URL 304 of the destination web page for the search result, and a search result snippet 306 that provides a summary of the search result. The search result 300 also includes a number of deeplinks 308 and a number of action-based deeplinks 310, each of which link to a corresponding destination web page. As can be seen from FIG. 3, the search result 300 includes both deeplinks 308 and action-based based deeplinks 310. The deeplinks 308 are specific to the particular web page (i.e., corresponding with www.alaskaair com), while the action-based deeplinks 310 were identified by analyzing web pages within the airlines category, for instance using the system described above with reference to FIG. 2. Additionally, the deeplinks 308 and action-based deeplinks 310 are displayed differently. In particular, the action-based deeplinks 310 are shown more prominently, using an icon and larger text for each.

Turning next to FIG. 4, another example of a search result 400 is provided. The search result 400 includes a title 402, the URL 404 of the destination web page for the search result 400, and a search result snippet 406. The search result also includes a number of deeplinks 408 and an action-based deeplink 410. In the example of FIG. 4, only a single action-based deeplink 410 is provided. Additionally, the action-based deeplink 410 is presented using only an icon.

In some embodiments, the action-based deeplinks displayed for search results corresponding with each web page in a given category may be consistent across the search results. That is, action-based deeplinks may be provided for the same actions. Additionally, the action-based deeplinks may be presented in a similar manner using common anchor text and/or icons. Accordingly, while the deeplinks presented may vary from web page to web page, the action-based deeplinks may be similar or the same. For instance, when search results for other airlines' web pages are provided in response to search queries, the deeplinks may be different from the deeplinks 308 shown in FIG. 3. However, the action-based deeplinks provided for each search result may be similar to the action-based deeplinks 310 shown in FIG. 3. As noted above, by providing a consistent group of action-based deeplinks for web pages within a category, users may be provided a more consistent experience. As a result, users may be able to more quickly recognize the action-based deeplinks and access a location to perform a desired action.

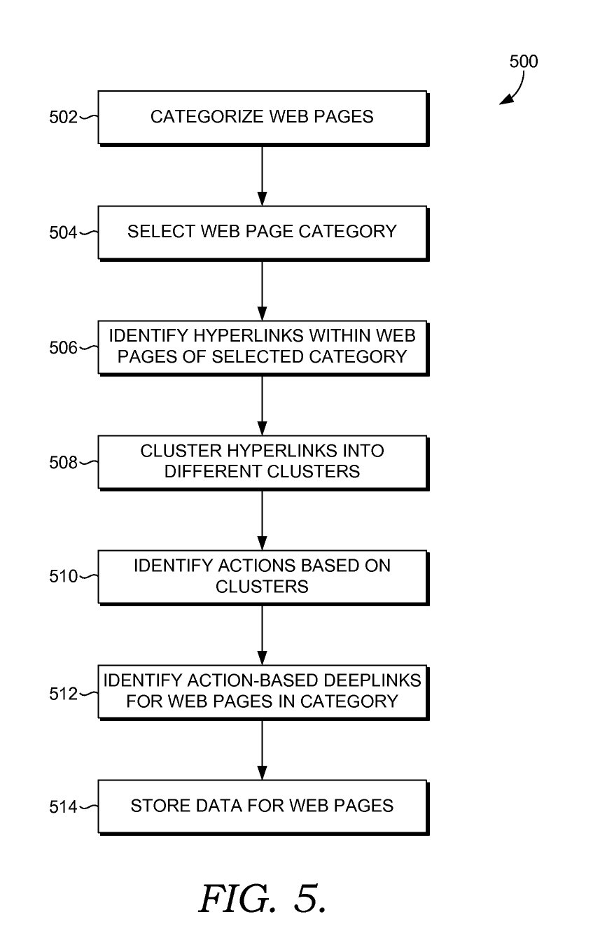

With reference now to FIG. 5, a flow diagram is provided that illustrates a method 500 for identifying action-based deeplinks in accordance with an embodiment of the present invention. As shown at block 502, a number of web pages are categorized. Web page categorization may be accomplished in a variety of ways. In some embodiments, web pages may be automatically clustered into categories based on, for instance, the content of the web pages. In some embodiments, an editorial approach may be employed in which web pages may be manually categorized. In further embodiments, an existing web page categorization, such as ODP, may be employed.

As shown at block 504, a web page category is selected for analysis. Hyperlinks within the web pages within the selected category are identified, as shown at block 506. In some embodiments, all hyperlinks contained within those web pages may be identified for further processing. However, in other embodiments, only a subset of hyperlinks may be employed. For instance, some embodiments may identify hyperlinks to consider based on user click data representing user clicks on hyperlinks when users visit the web pages or user clicks on deeplinks in search results, the deeplinks corresponding with particular hyperlinks in the web pages.

The hyperlinks are clustered into a number of clusters, as shown at block 508. In various embodiments, the hyperlink clustering may be based on the anchor text of the hyperlinks, the content of the destination web pages corresponding with the hyperlinks, and/or other data. Common actions for the category of web pages are identified based on the hyperlink clusters, as shown at block 510. In particular, a cluster may be identified as corresponding with a particular action. In some instances, an action is identified for each cluster. In other embodiments, actions are only identified for clusters that meet a threshold, which may be based on, for instance, a total number of hyperlinks within a given cluster, click-through data for hyperlinks within a given cluster, or other data.

Action-based deeplinks are identified for each action for at least a portion of the web pages in the category, as shown at block 512. The action-based deeplinks correspond with hyperlinks in the web pages that link to locations corresponding with each action. Data is stored identifying the action-based deeplinks for web pages, as shown at block 514. This allows for the action-based deeplinks to be provided with search results for the web pages in response to search queries.

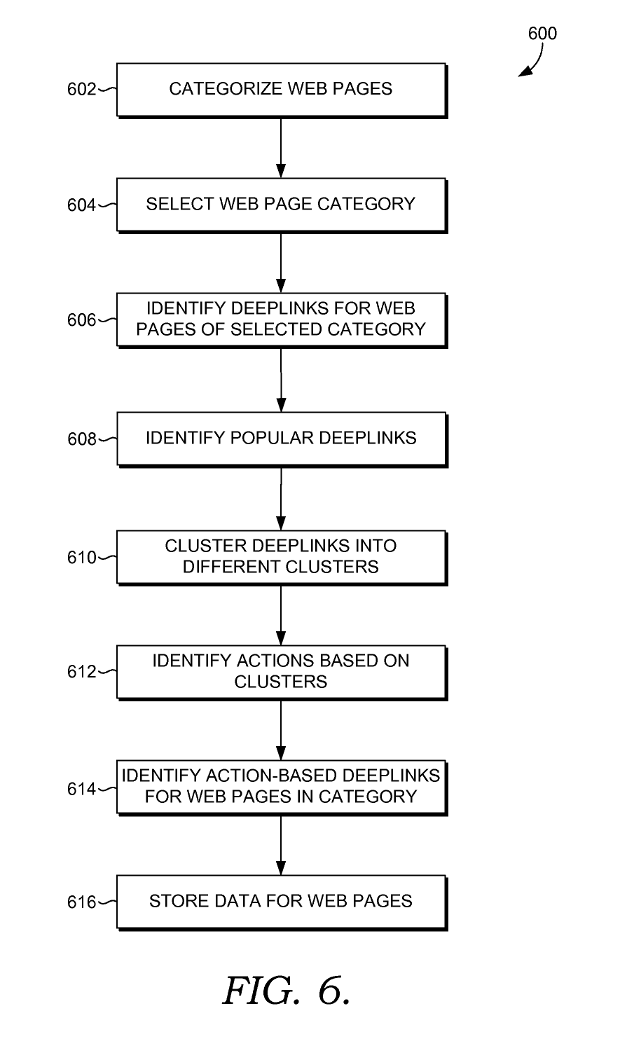

As indicated previously, some embodiments may identify action-based deeplinks by analyzing deeplinks from web pages within a given web page category as opposed to analyzing all hyperlinks from those web pages. This specific approach is illustrated in the method 600 shown in FIG. 6. As shown at block 602, web pages are categorized, and a web page category is selected for analysis at block 604.

Deeplinks for web pages in the selected category are identified, as shown at block 606. These deeplinks correspond with hyperlinks that are provided in association with search results for the web pages when returning the web pages as search results in response to search queries. The deeplinks may have been previously identified for the web pages, for instance, by analyzing the hyperlinks in the web pages to identify important or popular hyperlinks (e.g., based on user clicks on the hyperlinks when users visit the web pages).

Popular deeplinks are identified at block 608. This may be performed by analyzing click-through data for the deeplinks. The click-through data may comprise information regarding user clicks on deeplinks when the deeplinks are provided with search results in response to search queries. By way of example only and not limitation, the click-through data for a deeplink may include information such as raw click data or click-through rates based on the number of clicks on the deeplink as compared to the number of times the deeplink is returned with search results.

The popular deeplinks are clustered into a number of clusters, as shown at block 610. The clustering may be based on, for instance, the anchor text of the deeplinks and/or the content of the destination web pages of the deeplinks. Actions are identified based on the clusters of deeplinks, as shown at block 612. In some instances, an action may be identified for each cluster. In other instances, only clusters that satisfy some threshold may be considered for identifying an action. The threshold may be based on, for instance, the number of deeplinks within a cluster or the popularity of the deeplinks in a cluster (e.g., based on click-through data).

For each identified action, hyperlinks within web pages within the selected category are identified as corresponding with the action, as shown at block 614. This may be done for a given action by identifying the deeplinks within the cluster corresponding with the action. In some embodiments, the hyperlinks may be automatically identified by analyzing the anchor text of hyperlinks or content of the destination web pages of the hyperlinks. This may include comparison of the anchor text or content of the destination web pages to the action or the cluster of deeplinks corresponding with the action (for instance, the anchor text or destination web pages for those deeplinks). In further embodiments, the hyperlinks may be manually identified by editors who review the web pages to identify hyperlinks corresponding with an action.

As shown at block 616, data is stored identifying the action-based deeplinks for web pages. This allows for the action-based deeplinks to be provided with search results for the web pages in response to search queries.

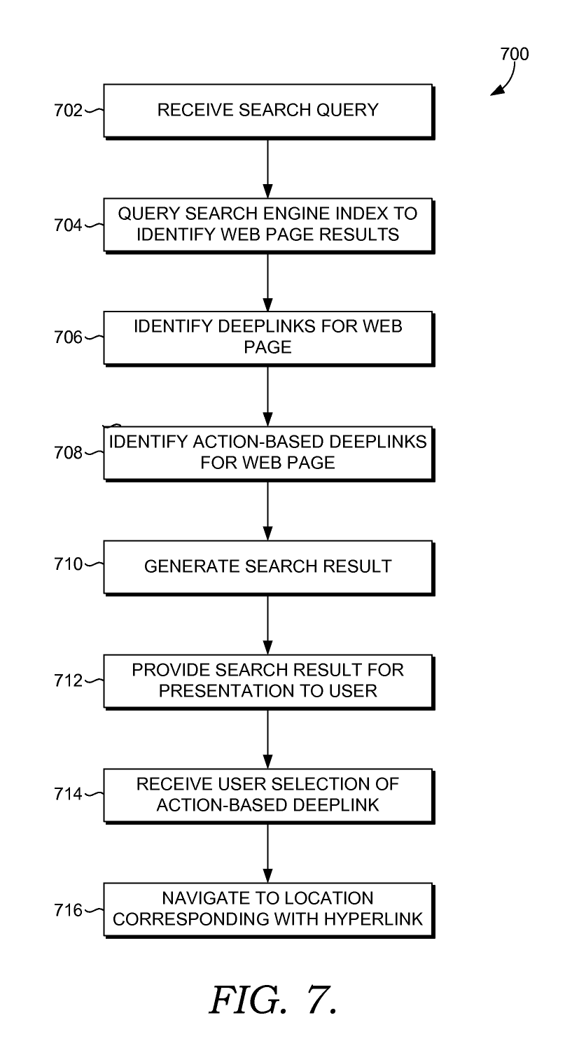

Turning now to FIG. 7, a flow diagram is provided that illustrates a method 700 for providing a search result that includes an action-based deeplink in response to a search query in accordance with an embodiment of the present invention. As shown at block 702, a search query is received from an end user. In response to the search query, a search engine index is searched to identify relevant web pages, as shown at block 704. Deeplinks are identified for one of the web pages, as shown at block 706. Action-based deeplinks are also identified for the web page, as shown at block 708. In particular, data may be stored for the web page, identifying deeplinks and action-based deeplinks for the web page. Accordingly, a search result is generated for the web page, as shown at block 710. The search result may include a hyperlink to the web page, the deeplinks, and the action-based deeplinks. The search result is provided to the end user device for presentation to the end user, as shown at block 712.

When the search result is presented, the search result may include a hyperlink to a destination web page corresponding with the search result. Additionally, the search result may include the deeplinks and the action-based deeplinks, which link to different web pages. In embodiments, the search result may include any number of deeplinks and action-based deeplinks. In some embodiments, the action-based deeplinks may be presented more prominently than the traditional deeplinks. The end user may select an action-based deeplink from the search result, as shown at block 714. In response to the user selection, the end user is navigated to the destination web page corresponding with the selected action-based deeplink, as shown at block 716.

### Action-Based Search Results and Action View Pivoting

In the approaches described hereinabove, given a particular URL associated with a search result, action-based deeplinks and other deeplinks may be provided for that search result to allow end users to access particular actions and tasks in various domains. This approach may also be flipped around. In particular, given a particular action, the URLs that best allow an end user to perform that action may be provided to the user as search results. These may be viewed as “action-based” search results and may include deeplinks to web pages at which the particular action may be performed.

Generally, given a particular action, a number of action-based search results are identified that include deeplinks to perform that action. The action-based search results for a given action may be identified using approaches described hereinabove for identifying actions corresponding with various URLs. The action-based search results identified for a given action may be provided to an end user to allow the end user to view the results and access a particular link to perform the action as desired.

An action may be identified and action-based search results returned in a number of different contexts. For example, in some instances, an end user may submit a search query to a search engine. The search engine may analyze the search query and identify a corresponding action. By way of illustration, suppose that an end user submits the search query “book a flight.” The search engine may analyze that search query and determine that the search query corresponds with an action for booking a flight. Note that any number of different search queries may be received and identified as corresponding with the action for booking a flight (e.g., “flight reservations,” “flight options,” “purchase airline tickets,” etc.). Based on identification of the “book a flight” action for the search query, search results that include deeplinks to web pages that allow the end user to book a flight may be identified and returned to the end user. This provides a convenient way for the end user to view and access the various locations at which the end user may perform the action. In the present example, the action-based search results would include websites from the various airlines that include links to the web pages at the airlines' websites for booking a flight. The end user may review the list and select a book a flight deeplink for a particular airline.

Action-based search results may be returned to users in a number of different ways. In some instances, the action-based search results may be provided in conjunction with other search results (i.e., search results that do not contain a deeplink to perform the identified action). The action-based search results may be placed above the other search results (or otherwise in a separate position that may be more prominent) or the action-based search results may be commingled with the other search results. The action-based search results and other search results may be listed using some ranking order. For instance, the ranking order may be based on popularity of corresponding URLs (e.g., based on number of impressions, clicks, or other popularity metrics), relevance to the search query, and/or a variety of other factors.

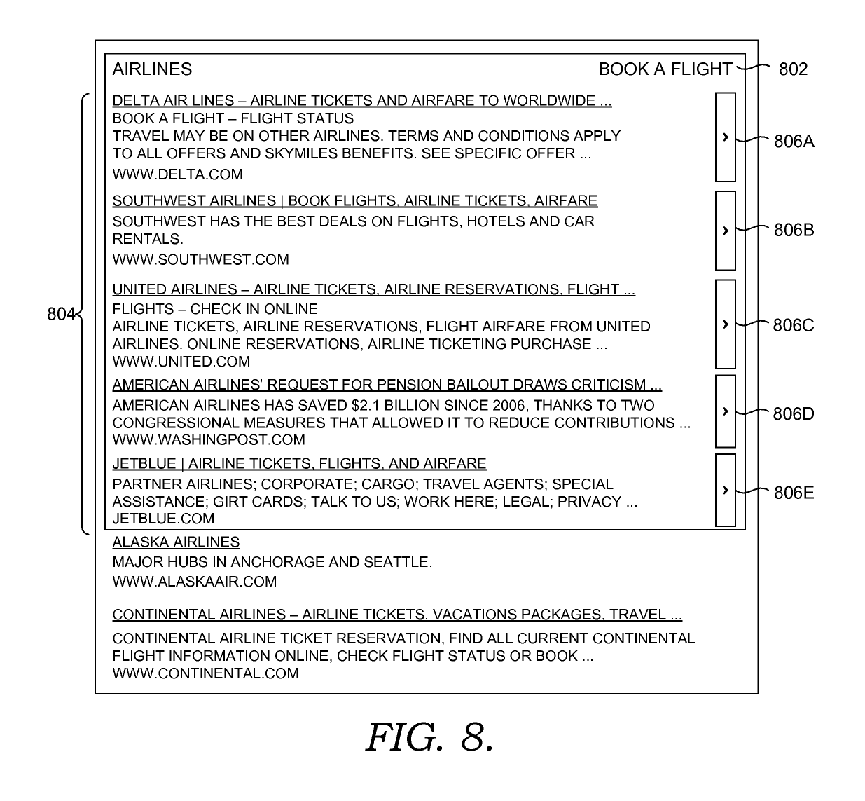

Another approach is to provide action-based search results in an “action view.” The action view may identify the relevant action and list the various search results with links to the web pages at which that action may be performed. For instance, FIG. 8 illustrates a screenshot showing an action view for the “book a flight” action. As shown in FIG. 8, the “book a flight” action 802 is identified with a list of airline websites 804 at which that action may be performed. For each search result (i.e., airlines website), a link (806A-806E) is provided to access a webpage within the airline website to book at flight at that airline.

The action-based search results may be ranked against one another (e.g., in an action view or otherwise) based on a variety of different factors. For instance, the action-based search results may be ranked based on popularity of corresponding URLs (e.g., based on number of impressions, clicks, or other popularity metrics) and/or various other factors.

Action-based search results may also be personalized based on whether the end user has previously interacted with particular URLs. Historical information may be stored for the end user and employed at run-time when selecting and ranking search results. For instance, whenever a user interacts with a particular website, webpage, deeplink, search result, etc. associated with an action-based search result, that action-based search result may receive a score boost.

In some instances, information may be collected regarding the end user's interactions with actions. If the end user has interacted more with a particular action in the past, that action may receive a score boost when determining what action a particular search query corresponds. For instance, suppose that an end user has interacted more frequently with a “book a flight” action than a “flight check-in action.” If the end user submits a query “flight,” the search engine may determine the search query corresponds with the “book a flight” action based on the end user's historical information, thereby personalizing the search results to the end user.

In other instances, an “action-pivot” link may be provided with search results that allows a user to pivot to a view with search results that provide deeplinks to a given action. In particular, when a user submits a search query and receives a set of search results, one or more of the search results may include a deeplink for a particular action. Given that deeplink, an action-pivot link may be provide for the action corresponding with that deeplink. If the user selects the action-pivot link, search results that include deeplinks to perform that action are identified and returned to the end user. For instance, suppose that the end user submits the search query “delta airlines,” and a set of search results is returned that includes a search result for the URL, www.delta.com, with a “book a flight” deeplink that allows a user to access a web page on the DELTA airlines website that allows a user to book on flight on that airline. Given that deeplink, an action-pivot link may be provided for the “book a flight” action. If the end user selects that action-pivot link, search results that include deeplinks to web pages that allow the user to book a flight may be identified and returned to the end user.

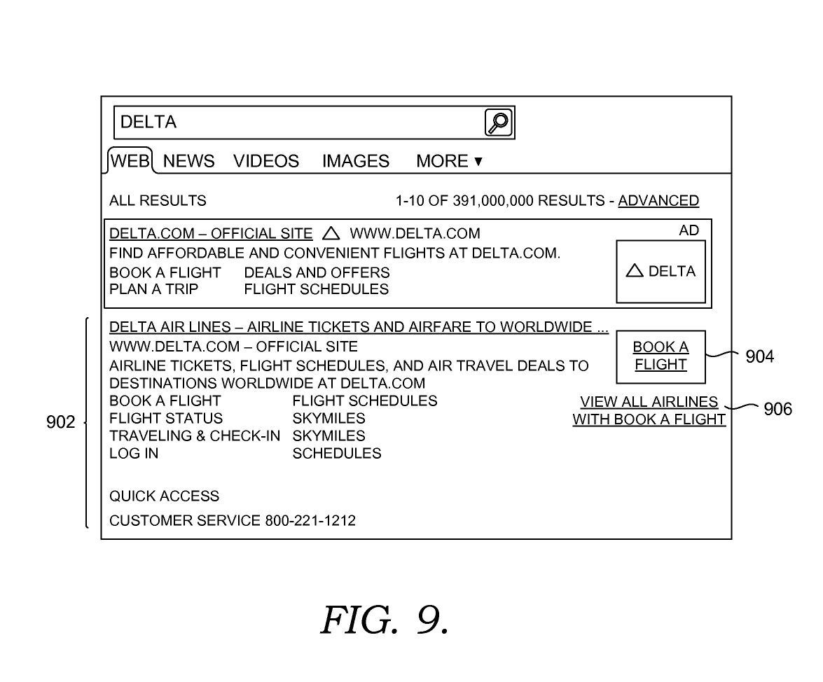

FIG. 9 illustrates a screenshot in an action-pivot link is provided as part of search results returned in response to search query. As shown in FIG. 9, the end user submitted the search query “delta” and search results have been returned that includes a search result 902 for the main page of the DELTA airlines website (i.e., www.delta.com). The search results include an action-based deeplink button 904 for the “book a flight” action. Additionally, an action-pivot link 906 is provided that corresponds with this action. If the end user selects the action-pivot link 906, search results with deeplinks to that action would be returned to the end user. For instance, the action view of FIG. 8 may be returned to the end user in response to the user selecting the action-pivot link 906.

In some embodiments, the end user may be able to pivot from an action view to a traditional search view. For instance, if the end user selects the action-pivot link from the traditional search result view of FIG. 9 to access the action view of FIG. 8, a link may be provided to allow the end user to pivot back to the traditional search result view. In that way, the user may pivot back and forth between the two views. In instances in which the end user is provided an action view in response to an original search query, a link may be provided that allows the end user to access a traditional search result view for the end user's original search query and/or based on any of the action-based search results in the action view.

In some instances, an action may be a parameterized action, such as that described in U.S. application Ser. No. 13/406,181, filed Feb. 27, 2012, (Attorney Docket Number 335156.01/MFCP.165729) entitled “Context-Aware Parameterized Action Links for Search Results.” In particular, a parameterized action is an action for which an end user may specify parameter values. By way of example to illustrate, real estate websites may commonly allow users to search for houses by specifying certain criteria. For instance, a user may search for houses at these websites by specifying parameters such as location, number of bedrooms, number of bathrooms, minimum price, maximum price, and other criteria. As such, a “find house” action may be identified as a parameterized action for these real estate websites. The parameters associated with the “find house” action may include any of the criteria that a user may specify (e.g., location, number of bedrooms, number of bathrooms, etc.).

When a search result is provided with a deeplink for a parameterized action, the parameters associated with the action may be identified and input boxes or other UI elements provided that allow a user to enter or otherwise specify values for the parameters. Those parameter values may be stored and/or may be used to populate parameterized deeplinks for other action-based search results having deeplinks for the same parameterized action.

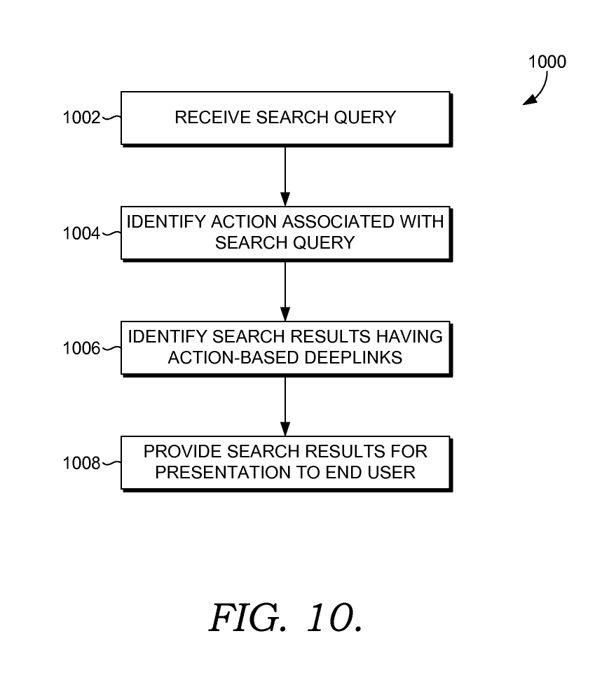

Referring now to FIG. 10, a flow diagram is provided that illustrates a method 1000 for providing action-based search results in response to a search query in accordance with an embodiment of the present invention. As shown at block 1002, a search query is received from an end user.

The search query is analyzed to identify an action associated with the search query, as shown at block 1004. A number of different approaches may be used for identifying an action associated with a search query in various embodiments of the invention. By way of example only and not limitation, different heuristics may be used as part of the analysis. For instance, a naïve approach may be employed in which the word edit distance between an action name (i.e., the name given to a particular action within the search engine system) and the received search query may be used to determine if the search query corresponds with the action. If the edit distance for a search query and action is within a threshold, the search query may be considered as corresponding with that action. It should be noted that multiple action names may be assigned to a given action and the search query may be compared against the various action names for that action.

Other approaches for identifying a search query as corresponding with a particular action may be employed. For instance, the search results identified for the search query using the search engine's traditional web search algorithm may be analyzed. In some instances, deeplinks associated with those search results may be identified and employed to determine the search query as corresponding with a particular action. If a threshold number of search results include a deeplink for the same action, the search query may be determined as corresponding with that action. For instance, if a number of the search results include the “book a flight” deeplink, the search query may be determined to correspond with the “book a flight” action.

In other instances, entities associated with search results may be identified and an action associated with those entities may be determined. For instance, if the search results include websites for a number of airlines, the entity associated with the search results may be determined to be airlines. Given the knowledge acquired using the above-described approaches, it may be determined that an action associated with that entity is the “book a flight” action.

Search results are identified based on the action, as shown at block 1006. In particular, search results with deeplinks that link to web pages at which the action may be performed are identified. These deeplinks may have been previously identified using methods such as those described hereinabove for identifying action-based deeplinks. As discussed above, actions and corresponding deeplinks to web pages at which those actions may be performed may be identified. In some instances, a mapping database may be generated based on this information. The mapping database may including mappings from actions to URLs, web pages, websites, deeplinks, or other information that may be used for selecting search results that provide deeplinks to web pages for performing the action. In some instances, the various URLs, web pages, websites, deeplinks, etc. for a given action may be ranked within the mapping database based on various factors, such as the popularity associated with each (e.g., based on impressions, clicks, etc.). Accordingly, the selection of search results at block 1006 may include referring to the mapping database to identify search results based on the information stored for the identified action. The search results may be ordered based on any ranking stored as part of the mapping database.

The search results are provided in response to the search query for presentation to the end user, as shown at block 1008. These search results are considered as action-based search results and include deeplinks to locations for performing the action. As discussed previously, the action-based deeplinks may be presented alone (e.g., in an action view such as that shown in FIG. 8) or may be presented with other search results that do not include deeplinks for the action.

In some instances, the type of search results returned by a search engine may be dependent on the type of search query received. More particularly, the search engine may analyze a search query to determine if it is an action-based search query (i.e., a search query that directed to a particular query). If an action-based search query is received, action-based search results may be returned. Alternatively if a non-action-based search query is received, traditional search results using the search engine's general web search or other algorithm may be returned. For instance, if the search query is “book a flight,” the search engine may identify it as an action-based search query. However, if the search query is “delta,” the search engine may identify it as a traditional search query and not an action-based search query. In particular, the “book a flight” search query more clearly exhibits a desire by the end user to perform a particular action. In contrast, the “delta” search query does not exhibit a particular action as clearly, as there are a number of various actions available and/or the end user may simply desire to access particular information.

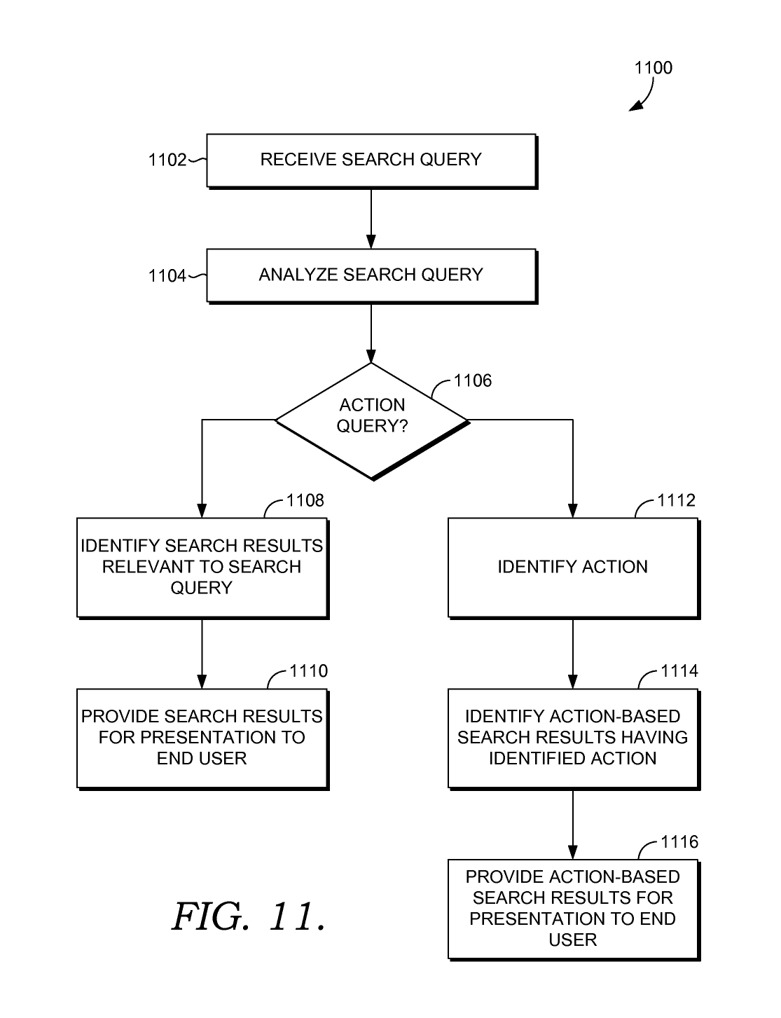

FIG. 11 includes a flow diagram that illustrates a method 1100 for returning different types of search results based on the type of search query received. As shown at block 1102, a search query is received from an end user. The search query is analyzed at block 1104 to determine if the search query is an action-based search query. A number of different approaches may be employed to determine whether a search query is an action-based search query. For instance, a action query classifier may be built and employed to determine whether a search query issued by an end user is an action-based search query that is directed to a particular action. The classifier may use a variety of different approaches. For instance, the various heuristics discussed above with reference to FIG. 10 may be employed.

If it is determined at block 1106 that the search query is not an action-based search query, search results relevant to the search query are identified as traditionally performed by search engine, as shown at block 1108. Generally, a traditional algorithm is employed to identify search results. The algorithm may employ any number of factors for search result selection, as is known in the art. The search results are provided for presentation to the end user, as shown at block 1110.

Alternatively, if it is determined at block 1106 that the search query is an action-based search query, the action associated with the search query is identified, as shown at block 1112. Identification of the action may be a result of analyzing whether the search query is an action-based search query.

Search results are identified based on the action, as shown at block 1114. In particular, search results with deeplinks that link to web pages at which the action may be performed are identified. This may be performed as discussed above with reference to FIG. 10.

The search results are provided in response to the search query for presentation to the end user, as shown at block 116. These search results are considered as action-based search results and include deeplinks to locations for performing the action. As discussed previously, the action-based deeplinks may be presented alone (e.g., in an action view such as that shown in FIG. 8) or may be presented with other search results that do not include deeplinks for the action.

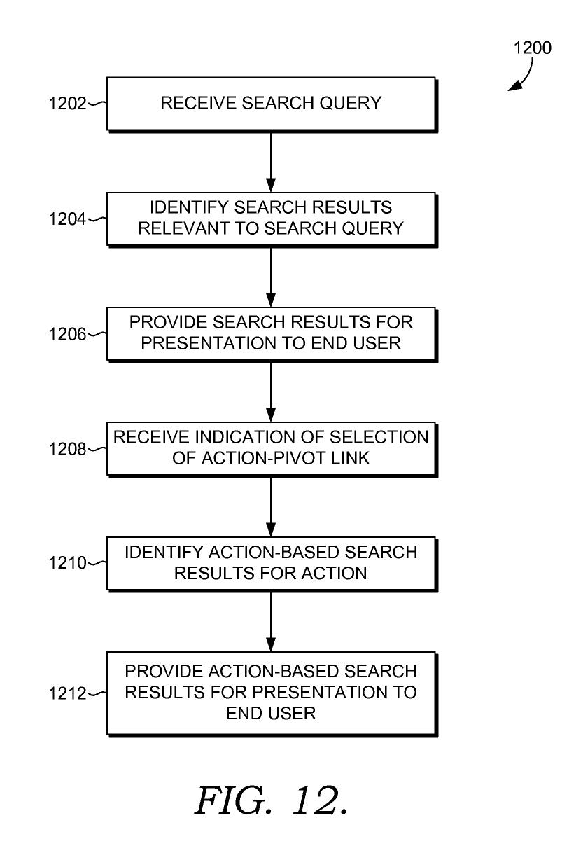

With reference now to FIG. 12, a flow diagram is provided that illustrates a method 1200 for employing an action-pivot link from a traditional search result to retrieve action-based search results in accordance with an embodiment of the present invention. As shown at block 1202, a search query is received. Search results are identified in response to the search query, as shown at block 1204. The search results may be identified using traditional search engine algorithms, as is known in the art. At least one of the search results includes a deeplink to a web page at which a particular action may be performed. The search results are provided for presentation to the end user, as shown at block 1206. An action-pivot link for the particular action corresponding with the deeplink is included as part of the search results. In some instances, the action-pivot link may be provided with the search result having the deeplink for that action (e.g., as shown in FIG. 9). In other instances the action-pivot link may be provided at another location (e.g., at the top of the search result list or other location). In some embodiments, action-pivot links may be included for multiple actions.

An indication that the end user has selected the action-pivot link is received, as shown at block 1208. In response to receiving the indication, action-based search results are identified, as shown at block 1210. The action-based search results include deeplinks to web pages at which the action may be performed. This may include identifying the action corresponding with the action-pivot link and identifying action-based search results for that action. The action-based search results are provided for presentation to the end user, as shown at block 1212. In some instance, the action-based search results may be provided in conjunction with one or more search results originally returned at block 1206. In other instances, the action-based search results are provided in a new view (e.g., an action view). This latter approach allows the end user to pivot from a traditional search result view (e.g., FIG. 9) with traditional search results to an action view (e.g., FIG. 8) with action-based search results and the particular action identified.

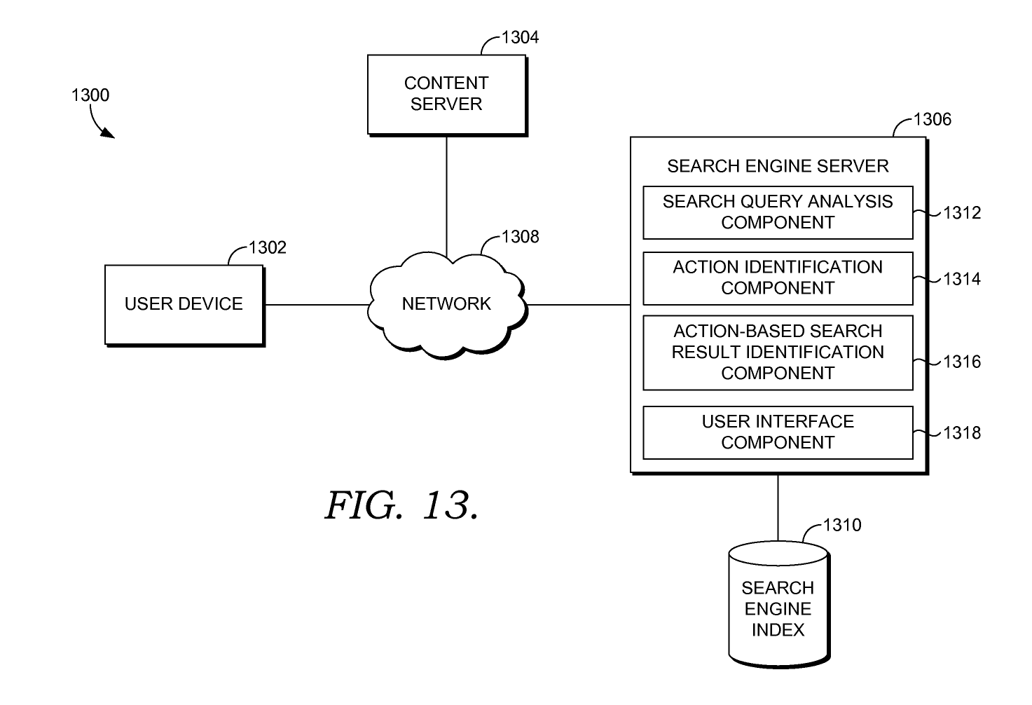

Referring next to FIG. 13, a block diagram is provided illustrating an exemplary system 1300 in which some embodiments of the present invention may be employed. It should be understood that this arrangement is set forth only as an example. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 1300 may include a user device 1302, content server 1304, and search engine server 1306. Each of the components shown in FIG. 13 may be any type of computing device, such as computing device 100 described with reference to FIG. 1, for example. The components may communicate with each other via a network 1308, which may include, without limitation, one or more local area networks (LANs) and/or wide area networks (WANs). Such networking environments are commonplace in offices, enterprise-wide computer networks, intranets, and the Internet. It should be understood that any number of user devices, content servers, and search engine servers may be employed within the system 1300 within the scope of the present invention. Each may comprise a single device or multiple devices cooperating in a distributed environment. For instance, the search engine server 1306 may comprise multiple devices arranged in a distributed environment that collectively provide the functionality of the search engine server 1306 described herein. Additionally, other components not shown may also be included within the system 1300.

The search engine server 1306 generally operates to index information regarding web pages served by content servers, such as the content server 1304, in a search engine index 1310. When the search engine server 1306 receives search queries from user devices, such as the user device 1302, the search engine queries the search engine index 1310 to identify search results based on the end users' search queries and returns those search results to the user devices. In accordance with some embodiments of the present invention, the search engine server 1306 is also configured to identify an action and to provide action-based search result corresponding with that action.

In the embodiment shown in FIG. 13, the search engine server 1306 includes, among other things, a search query analysis component 1312, an action identification component 1314, an action-based search result identification component 1316, and a user interface component 1318. Although not shown in FIG. 13, the search engine server 1306 may include components from the search engine server 206 described above with reference to FIG. 2, for instance, to categorize websites and identify actions common to websites within given categories.

The user interface component 1318 provides an interface to user devices, such as the user device 1302, that may allow end users to submit search queries to the search engine server 1306, to receive search results from the search engine server 1306, and to otherwise interact with the search engine server 1306. It should be understood that the user device 1302 may be any type of computing device employed by a user to submit search queries and receive search results. By way of example only and not limitation, the user device 1302 may be a desktop computer, a laptop computer, a tablet computer, a mobile device, or other type of computing device. The user device 1302 may include an application that allows a user to enter a search query and submit the search query to the search engine server 1306 to retrieve search results. For instance, the user device 1302 may include a web browser that includes a search input box or allows a user to access a search page to submit a search query. Other mechanisms for submitting search queries to search engines are contemplated to be within the scope of embodiments of the present invention.

The search query analysis component 1312 operates to analyze received search queries to determine if the search queries are action-based search queries. The search query analysis component may analyze a search using an approach such as that described above with reference to FIG. 11. For instance, the search query analysis component 1312 may employ a query classifier to determine whether an issued search query is an action-based search query.

The action identification component 1314 operates to identify an action. In some instances, the action may be identified based on a received search query (e.g., as in FIGS. 10 and 11). In other instance, the action may be identified in response to an end user selecting an action-pivot link (e.g., as in FIG. 12). Actions may be identified by the action identification component 1314 in other contexts in various embodiments of the present invention.

The action-based search query identification component 1316 operates to identify action-based search queries based on an action identified by the action identification component 1314. In some embodiments, this may include accessing a mapping database (not shown) that maps actions to corresponding URLs associated with the action. The search results may be identified by locating the action in the mapping database and identifying search results based on the information mapped to the action.

Although not shown in FIG. 13, it should be understood that some components provided on the search engine server 1306 may be provided on the user device 1302 such that the operations of those components may be performed on the user device 1302 or the operations may be performed in part by the search engine server 1306 and in part by the user device 1302.

Advertisements with Action-Based Deeplinks

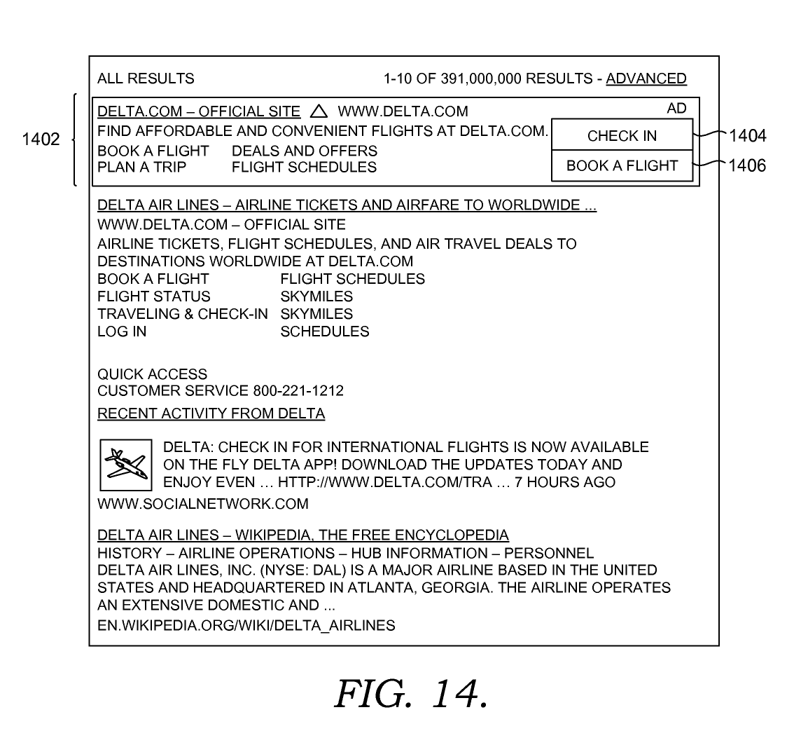

Action-based deeplinks may also be provided with advertisements. As used herein, an advertisement is a paid search result. That is, the search result is displayed in a manner in which an advertiser or other entity pays for the placement of the search result. For instance, FIG. 14 illustrates a screenshot of search results with the advertisement 1402 placed at the top. As shown in FIG. 14, the advertisement includes action-based deeplinks 1404 and 1406.

The action-based deeplinks to include with an advertisement may be manually identified for the advertisement by the advertiser and/or the action-based deeplinks may be algorithmically determined, for instance using the approaches for identifying action-based deeplinks discussed hereinabove.

Accordingly, when a search query is received, an advertisement may be selected in a traditional manner (e.g., using an auction or other process), and the advertisement may be presented with search results. If the advertisement includes action-based deeplinks, the action-based deeplinks may be displayed as part of the advertisement (e.g., as shown in FIG. 14). In some instance, the advertiser may be charged an additional fee (e.g., higher cost-per-impression, higher cost-per-click, etc.) for inclusion of action-based deeplinks with an advertisement.

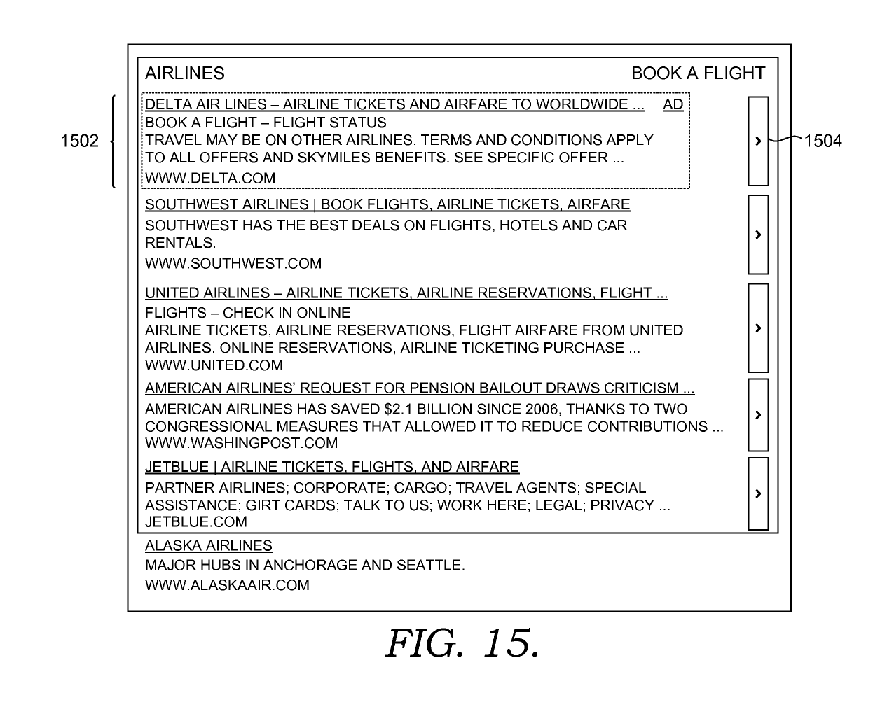

Advertisements with action-based deeplinks may also be selected and returned when action-based search results are returned. For instance, when an action-based search query is submitted or an action-pivot link is selected, an advertisement that has an action-based deeplink corresponding with the particular action may be selected and provided with the non-paid action-based search results. By way of illustration, FIG. 15 provides a screenshot that illustrates an action view for the “book a flight” action. As shown in FIG. 15, the top position is an advertisement 1502 that includes a deeplink 1504 for the “book a flight” action.

As can be understood, embodiments of the present invention include identifying actions and providing action-based search results relevant to the actions. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method, the instructions comprising:
receiving a search query from an end user;
identifying an action associated with the search query;
identifying a plurality of search results based on the action, each search result having an action-based deeplink to a corresponding web page for performing the action; and
providing a search result set for presentation to the end user, the search result set including the plurality of search results.

2. The one or more computer storage media of claim 1, wherein identifying the action associated with the search query comprises identifying the search query as an action-based search query.

3. The one or more computer storage media of claim 2, wherein the search query is identified as an action-based search query by analyzing the search query using one or more heuristics.

4. The one or more computer storage media of claim 1, wherein the instructions further comprise generating a mapping database that maps actions to web pages that have the action.

5. The one or more computer storage media of claim 1, wherein the plurality of search results are identified from the mapping database.

6. The one or more computer storage media of claim 1, wherein the search result set includes other search results not having an action-based deeplink to a corresponding web page for performing the action.

7. The one or more computer storage media of claim 6, wherein the instructions further comprise ranking the plurality of search results and the other search results to commingle the plurality of search results with the other search results.

8. The one or more computer storage media of claim 1, wherein the search result set is presented within an action view that identifies the action and list the plurality of search results with the action-based deeplink for each search result.

9. The one or more computer storage media of claim 1, wherein the action is a parameterized action, and the action-based deeplink presented for each search result is a parameterized action-based deeplink that allows the end user to enter values for parameters of the parameterized action.

10. The one or more computer storage media of claim 9, wherein the instructions further comprise:
receiving parameter values from the end user for a first action-based deeplink; and
populating other action-based deeplinks with the parameter values.

11. The one or more computer storage media of claim 1, wherein the instructions further comprise:
identifying an advertisement that has an action-based deeplink corresponding with the action; and
providing the advertisement with the search result set.

12. The one or more computer storage media of claim 1, wherein the plurality of search results are ranked at least in part based on historical information for the end user.

13. A method comprising:
receiving a search query from an end user;
analyzing the search query to determine if the search query is an action-based search query;
if it is determined that the search query is not an action-based search query:
identifying search results relevant to the search query, and
providing the search results relevant to the search query for presentation to the end user;
if it is determined that the search query is an action based search query:
identifying an action corresponding with the search query,
identifying action-based search results based on the action, each action-based search result having an action-based deeplink to a corresponding webpage for performing the action, and
providing the action-based search results for presentation to the end user.

14. The method of claim 13, wherein the search query is analyzed to determine if the search query is an action-based search query by employing one or more heuristics.

15. The method of claim 13, wherein the action-based search results are provided in an action view that identifies the action and lists the action-based search results with an action-based deeplink for the action provided for each action-based search result.

16. One or more computer storage media storing computer-useable instructions that, when used by one or more computing devices, cause the one or more computing devices to perform a method, the instructions comprising:
receiving a search query from an end user;
identifying a plurality of search results relevant to the search query, a first search result within the plurality of search results having a deeplink to a webpage for performing an action;
providing the plurality of search results for presentation to an end user, wherein the first search result includes an action-pivot link corresponding with the action;
receiving an indication that the end user has selected the action-pivot link;
responsive to receiving the indication that the end user has selected the action-pivot link, identifying a plurality of action-based search results, each action-based search result including a deeplink to a corresponding webpage for performing the action; and
providing the action-based search results for presentation to the end user.

17. The one or more computer storage media of claim 16, wherein the plurality of search results includes a paid search result with a deeplink to a webpage for performing the action.

18. The one or more computer storage media of claim 16, wherein a second pivot link is provided with the action-based search results that when selected by the end user, causes the plurality of search results to be displayed.

19. The one or more computer storage media of claim 16, wherein the action-based search results are provided in an action view that identifies the action and lists the action-based search results with the deeplinks to corresponding web pages for performing the action.

20. The one or more computer storage media of claim 16, wherein the instructions further comprise:
identifying an advertisement that has an action-based deeplink corresponding with the action; and
providing the advertisement with the action-based search results.
